(19) United States
(12) Patent Application Publication
(10) Pub. No.: US 2006/0197240 A1
(43) Pub. Date: Sep. 7, 2006

(54) COLLECTING TRAY WITH LOW HEAT TRANSFER COEFFICIENT FOR A RECTIFICATION COLUMN

(75) Inventors: Armin DIEFENBACHER, Germersheim (DE); Klaus Joachim MUELLER-ENGEL, Stutensee (DE); Ulrich HAMMON, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/276,174

(22) Filed: Feb. 16, 2006

Related U.S. Application Data
(60) Provisional application No. 60/657,431, filed on Mar. 2, 2005.

(30) Foreign Application Priority Data
Mar. 2, 2005 (DE) 10 2005 009 469.4

(51) Int. Cl. B01F 3/04

(52) U.S. Cl. 261/114.1

(57) ABSTRACT

A chimney tray for a column for the thermal treatment of a liquid, comprising an upper tray and a lower tray which are spaced apart from one another, arranged substantially horizontally in the column, comprising chimneys, and also comprising drawing of the liquid via a drainage spout arranged at the edge of the chimney tray, wherein the upper tray and the lower tray have a minimum separation from one another of from 10 to 500 mm and, between the upper tray and the lower tray, a gas having a thermal conductivity of less than 0.5 watt/m/K has been incorporated.

The invention relates to a chimney tray for a column for the thermal treatment of a liquid, and to a process for thermal treatment in a column.

Chimney trays are well known to be a special embodiment of column trays having chimneys for vapor passage, which are covered by rigid covering hoods which are immersed into the liquid. Column trays are plate-shaped construction elements which are arranged horizontally, reinforced by U-profiles and generally (depending on the diameter, individually or combined as a package to a plurality) secured on the column jacket and sealed against it in a liquid-tight manner (cf. K. Sattler: Thermische Trennverfahren [Thermal separating processes], Verlag Chemie, 2nd edition, 1995, page 194).

It is frequently necessary to fully or partly remove the liquid present on the chimney trays in rectification or absorption columns. To this end, the liquid can be drawn off by means of a pump via a connecting line after a certain liquid head has been attained. However, this method is unsuitable owing to the large liquid accumulation and the associated long delay time for the treatment of thermally unstable substances, for example of (meth)acrylic acid and its esters, of acrylonitrile, styrene, etc., owing to the polymerization tendency thereof.

A further method of liquid withdrawal consists in equipping the chimney trays with an overflow weir, in which case the liquid flows from the chimney tray over this overflow weir into a ring channel disposed outside. The ring channel is tapped into by means of connecting lines at one or more points on the circumference, and the liquid is drawn off. This embodiment too is problematic for substances having increased polymerization tendency, since uncontrolled polymerization takes place in the ring channel owing to prolonged delay time and frequently high temperatures, so that the functioning of the columns is disrupted.

A multitude of designs have therefore already been proposed which ensure reduced delay time of the liquid on column trays:

For instance, DE-A 42 31 081 describes a mass transfer tray with integrated drawing means of the liquid phase in the form of a draw pan incorporated into a commercial mass transfer tray. A disadvantage in this context is that only a portion of the liquid can be removed from the column tray.

EP-A 1 088 576 proposes a funnel-shaped column tray with central liquid draw via a pipeline. A disadvantage of this design is that the arrangement of the pipeline in the central lower region of the funnel-shaped tray makes impossible simple and effective insulation thereof, which would be required to reduce the thermal stress on the liquid disposed on the tray.

DE-A 19526153 describes a total draw chimney tray with a gradient in the form of an upturned cone. A disadvantage here too is the central liquid draw via a pipeline.

DE-A-101 59 825 describes a chimney tray which is formed from an upper tray and a lower tray, with drawing of liquid via a drainage spout arranged at the edge of the chimney tray, the lower tray being arranged horizontally in the column and the upper tray having one or more drainage channels with a gradient toward the drainage spout, and the upper tray itself having a gradient toward the one or more drainage channels. This embodiment is intended to reduce the delay time of the liquid on the chimney tray and thus the thermal stress on the liquid and its polymerization tendency.

It was accordingly an object of the invention to provide a chimney tray which has been improved further for columns for thermally treating liquids, in which, in addition to a lower thermal stress for the liquid on the column trays, condensation from the gas phase on the lower tray is prevented or substantially reduced.

The solution starts from a chimney tray for a column for the thermal treatment of a liquid, comprising an upper tray and a lower tray which are spaced apart from one another, arranged substantially horizontally in the column, comprising chimneys, and also comprising drawing of the liquid via a drainage spout arranged at the edge of the chimney tray.

The characterizing features of the invention are that the upper tray and the lower tray have a minimum separation from one another of from 10 to 500 mm and, between the upper tray and the lower tray, a heat-insulating material having a thermal conductivity of less than 0.5 W/m/K has been incorporated.

The upper and the lower tray are preferably each formed from metal sheets which are joined to one another via supporting and connecting elements.

Upper tray and lower tray are arranged substantially horizontally in the column. The lower tray barely deviates from the horizontal. In contrast, the upper tray has a gradient in the direction toward the drainage spout, which is preferably in the range from 0.2 to 5°, in particular in the range from 0.5 to 3°.

The upper tray is preferably equipped with one or more drainage channels which are formed from curved metal sheets and have a gradient in the direction toward the drainage spout, and the upper surface has a gradient in the direction toward the one or more drainage channels.

Preference is given to a minimum separation between upper tray and lower tray in the range from 50 to 400 mm and a thermal conductivity of the medium between upper tray and lower tray of less than 0.1 watt/m/K. Preference is further given to the minimum separation between upper tray and lower tray being between 100 and 300 mm.

It is possible to incorporate a gas as a heat-insulating material into the intermediate space between upper tray and lower tray, for example air.

It is also possible, additionally or alternatively, to incorporate a solid insulating material.

The chimneys disposed on the chimney tray may advantageously have a double-wall configuration, in particular with a ratio of external diameter to internal diameter of less than 1.25, more preferably less than 1.1.

Advantageously, the lower tray is formed initially with orifices which allow pressure equalization in the course of static testing with liquid before startup of the column and which are sealed in a gas- and liquid-tight manner, preferably welded, after completion of the static testing.

The invention also provides a process for thermally treating, preferably for rectifying or absorbing, a fluid mixture in a column having chimney trays as described above, wherein the fluid mixture comprises thermally unstable compounds, in particular (meth)acrylic acid and/or its esters, acrylonitrile and/or styrene.

The inventive chimney tray ensures operation with reduced fouling in the thermal treatment of liquids which tend to polymerize, by not only reducing the delay time on the chimney tray but also by minimizing the heat transfer through the chimney tray and thus in particular also preventing the condensation of ascending vapors on the lower tray.

What is claimed is:

1. A chimney tray for a column for the thermal treatment of a liquid, comprising an upper tray and a lower tray which are spaced apart from one another, arranged substantially horizontally in the column, comprising chimneys, and also comprising drawing of the liquid via a drainage spout arranged at the edge of the chimney tray, wherein the upper tray and the lower tray have a minimum separation from one another of from 10 to 500 mm and, between the upper tray and the lower tray, a heat-insulating material having a thermal conductivity of less than 0.5 W/m/K has been incorporated.

2. The chimney tray according to claim 1, wherein upper tray and lower tray are formed from metal sheets.

3. The chimney tray according to claim 1, wherein the minimum separation between upper tray and lower tray is from 50 to 400 mm and the thermal conductivity of the heat-insulating material between upper tray and lower tray is less than 0.1 W/m/K incorporated.

4. The chimney tray according to claim 3, wherein the minimum separation between upper tray and lower tray is from 100 to 300 mm.

5. The chimney tray according to claim 1, wherein the heat-insulating material is a gas.

6. The chimney tray according to claim 1, wherein the heat-insulating material between upper tray and lower tray is a solid insulating material.

7. The chimney tray according to claim 1, wherein the lower tray is arranged horizontally in the column and the upper tray has one or more drainage channels having gradients in the direction of the drainage spout and gradients in the direction toward the drainage channel(s).

8. The chimney tray according to claim 1, wherein the chimneys have a double-wall design, with a ratio of external diameter to internal diameter of less than 1.25.

9. The chimney tray according to claim 8, wherein the ratio between external diameter and internal diameter of the chimneys is less than 1.1.

10. The chimney tray according to claim 1, wherein the lower tray is equipped initially with orifices which allow pressure equalization in the course of static testing with liquid before startup of the column and which are welded after completion of the static testing.

11. A process for thermally treating, preferably for rectifying or absorbing, a fluid mixture in a column having chimney trays (1) according to claim 1, wherein the fluid mixture comprises thermally unstable compounds, in particular (meth)acrylic acid and/or its esters, acrylonitrile and/or styrene.
